(19) United States
(12) Patent Application Publication
(10) Pub. No.: US 2013/0006779 A1
(43) Pub. Date: Jan. 3, 2013

(54) Process for occasion based gift giving through social media networks

(76) Inventor: Eddie Brian Belluomini, Mililani, HI (US)

(21) Appl. No.: 13/135,347

(22) Filed: Jun. 29, 2011

(51) Int. Cl. G06Q 30/06; G06Q 30/02

(52) U.S. Cl. 705/14.69; 705/27.1

(57) ABSTRACT

A process for gifting through a social media network with credits redeemable through preferred vendors only.

### TECHNICAL FIELD

The present invention generally relates to occasion based gift giving through social media networks.

### BACKGROUND ART

Social media networks have become important parts of society and culture. However, the companies that operate social media networks, such as Facebook and Myspace, have not been able to create revenue streams that maximize the potential of social media networks, even though social media networks have been in operation for many years and have hundreds of millions (if not billions) of users.

In social media networks, members can create profiles that contain various pages (such as a home page) where they can post photographs and information about themselves. Often, there is also an area on a page where other members of the social media network can upload messages, photographs, icons and other content. However, operators of social media networks have not been able to create revenue streams from their networks on the same scale as search engines, such as Google. Revenue from posting advertisements on pages of the social media network presently appears to be the only reliable method for generating revenue streams from social media networks, as was the case in the initial development of search engines. However, search engines, especially Google, were able to realize very substantial revenue streams by displaying a hierarchy of sponsored links on search results pages, and then charging advertisers varying fees depending on placement within the hierarchy of sponsored links, and depending on the manner in which the sponsored links would be triggered for display, such as through specific words typed in search requests. Thus, search engines have been able to generate substantial revenue streams using their inherent characteristics of providing search results. Social media networks presently lack the ability to generate substantial revenue streams through their inherent characteristics as social networks, even though the ability of members of social media networks to conduct financial transactions through social media networks has existed for decades, such as through Paypal. Further, Facebook already provides members with the ability to send virtual gifts to other members, such as virtual roses. However, the amounts charged for such virtual gifts are relatively small because they are not real gifts.

The following patent may be considered relevant to the field of the invention:

U.S. Pat. No. 7,933,810 to Morgenstern, incorporated herein by reference, discloses a method for collective gift giving in a social network environment, comprising receiving a request to establish a gift account; designating a recipient user of the social network to receive a gift; collectively voting on a gift for the recipient user; receiving money from a plurality of contributing users for deposit into the gift account; purchasing the selected gift using the deposited money; and providing the purchased gift to the recipient user.

Accordingly, it is an object of the present invention to provide a process by which a social media network can generate substantial revenue streams from activities beyond placing advertisements on members' pages.

It is a still further object of the present invention to provide such a process that enables members of social media networks to perform social monetary transactions, such as gift giving, in an efficient and timely manner.

It is a further object to provide such a process where a social network user can set up his or her own occasion-based account(s) and notify other members of the account(s), so that the other members who desire to give gifts can choose to add credits to the social network user's occasion-based account(s).

It is a further object to provide such a process where a social network user can receive a gift of his or her own choosing.

It is a further object to provide such a process that is easy to use, preferably without any added cost to members of the social network.

### DISCLOSURE OF THE INVENTION

The above and other objects are achieved by a process comprising appointing preferred vendors (“preferred merchants”) connected to a social media network, and enabling members of the social media network who desire to receive gifts (“recipient members”) to create their own occasion-based accounts that are designated to receive credits, such as monetary credits, for the occasions (“occasion accounts”). Preferably recipient members are able to notify other members of the social media network (preferably selected by the recipient members) about the occasion accounts.

Notified members of the social media network who desire to give gifts to the recipient members (“gifting members”) can then give credits to the occasion accounts through the social media network. Preferably only the recipient members are allowed to redeem the credits towards purchases and gifts of their own choosing made through the social media network, but only from the preferred vendors. The credits are preferably redeemed on a redemption page that contains click through links to the preferred vendors.

Preferably, the occasion accounts may be for gift giving occasions, such as birthdays, weddings, anniversaries, Christmas, graduations, bridal showers, and baby showers. Occasion accounts may also be used for charities and fundraisers, including (for example) fundraisers for the recipient's medical, legal or other expenses.

Preferably, the process further comprises allowing recipient members to select among preferred vendors to redeem the credits to purchase gifts of their own choosing, using selection criteria such as geographic proximity and personal interests of the recipient members.

Preferably, also, the occasion accounts have, or can be linked to, registries that are created by the recipients. Preferably, the redeeming of credits can be performed on a redemption page with click-through links to the preferred vendors, so that the operators of the social media network can receive click-through advertising revenues as well as advertising revenue from preferred vendors for their placement on the hierarchy of vendors listed on the redemption page.

The above and other objects are also preferably achieved by a downloadable computer-readable file or computer-readable storage medium containing instructions that, when executed, make a computer into a social media gifting machine preferably comprising software that: appoints preferred vendors connected to a social media network; enables recipient members to create their own occasion accounts that are designated to receive credits for occasions so that gifting members can give credits to the occasion accounts through the social media network; and allows only the recipient members to select gifts of their own choosing from the preferred vendors by redeeming the credits through a redemption page containing click through links to the preferred vendors.

### BRIEF DESCRIPTION OF DRAWINGS

FIG. 1 shows an example of a social media network page for a recipient member of the social media network.

FIG. 2 shows an example of a redemption page for a social media network member.

### BEST MODE FOR CARRYING OUT THE INVENTION

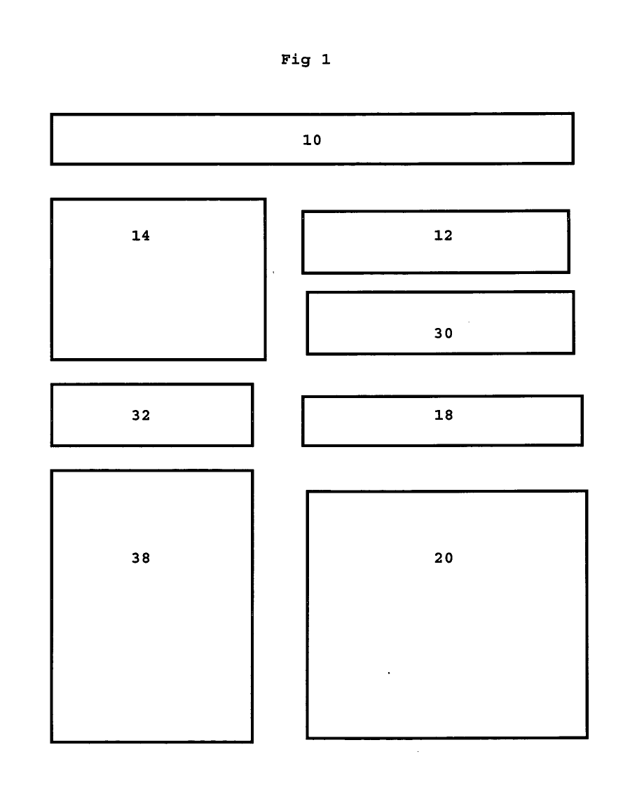

Referring to FIG. 1, shown is a recipient member social media network home page having a title bar 10 and a recipient member information area 12, displaying the recipient member's name and other personal information. Optionally, a recipient photo area 14 is also provided to display the recipient's photograph or other information. The recipient member's home page also contains an upload area title bar 18 for an upload area 20 where uploads from other members of the social media network can be displayed.

An occasion notice 30 can be displayed in a prominent area of the recipient member's home page, such as adjacent to the recipient member information area 12. An occasion account title bar 32 can also be provided in a prominent area on the page, and a credit announcement area 38 can be provided adjacently, preferably under the occasion account title bar 32.

With this structure, the occasion notice 30 can announce that, for example, the recipient member's birthday is approaching, and optionally display an icon or other design appropriate for the occasion. The occasion account title bar 32 can similarly display the title of the occasion and indicate that it is an account to which credits can be deposited. For example, the occasion account can be entitled “birthday bank” or some other similarly descriptive title. When gifting members of the social media network give credits to the occasion account 32, those gifting members can optionally input announcements to be displayed in the credit announcements area 38.

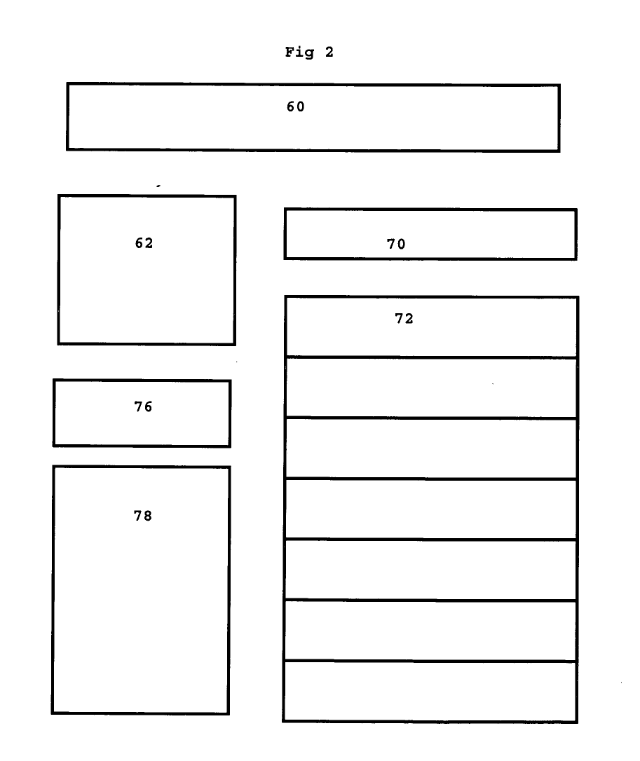

Referring to FIG. 2, shown is an example of a redemption page according to this invention. At the top is a redemption page title bar 60 and a recipient member information area 62 in which the recipient's name, photograph or other information can be displayed.

Optionally, the recipient member information area 62 can also include the title of the occasion account displayed in the occasion account title bar 32 on the recipient member's social media network home page.

Preferably, a preferred vendor's title bar 70 is provided in a prominent place on the redemption page, and a preferred vendors area 72 is provided adjacently, preferably directly underneath.

Optionally, a selection query box 76 is provided into which the recipient can input selection criteria, or perform other search functions to search among preferred vendors. Preferably, a selection criteria area 78 is also provided directly adjacent to the selection query box 76, preferably directly underneath, and various selection criteria or advertisements are listed in the selection criteria area 78. Optionally, the redemption page can provide links to, or display, registries created by recipient members, which contain desired gifts that have been selected by recipient members at preferred vendors.

As can be seen from the above, the operator of the social media network appoints preferred vendors that are connected to the social media network, and maintains a database of the preferred vendors. Recipient members can create their own occasion accounts that are designated to receive credits for occasions. Gifting members can give credits to the occasion accounts through the social media network. Preferably, recipient members can notify other members of the social media network about the recipient member's occasion account, such as by posting a notice in the occasion notice bar 30, or by directly contacting, or having the social media network contact or send a broadcast to, potential gifting members. An icon or other information can be displayed in the occasion account title bar 32 to notify other members of the occasion as well. The information displayed in the occasion notice bar 30 and the occasion account title bar 32 would preferably disclose the type of occasion, such as birthday, wedding, anniversary, Christmas, graduation, or baby shower. However, the occasion for the occasion accounts need not be a gift giving occasion and could be, for example, information for a charity or fundraiser.

The gifting members can purchase credits using an Internet financial transactions provider, such as Paypal, and then have those credits deposited in the occasion account. Optionally, the gifting members can post announcements of their gifts of credits in the credit announcements area 38. In this manner, the recipient members can conveniently and quickly receive multiple gifts of credits from gifting members of the social media network. The credits can be aggregated and then redeemed on a separate redemption page (FIG. 2).

The credits preferably can be redeemed only through the preferred vendors who are listed in the preferred vendors area 72. Optionally, the social media network can determine inclusion and placement in the preferred vendors area 72 based on, for example, payment of fees, geographic proximity, school or other affinity, or other criteria. Optionally, the selection query area 76 allows the recipient member to query the social media network's database of preferred vendors based on various criteria. For example, the selection query area 76 can display a map on which the recipient member can click to select vendors that are in geographic proximity to recipient members, for example only within a specific State or other area.

Additional searches can be accommodated by queries in the selection query bar 76, such as searches by business category or by vendor name. Also, links can be provided to selected types of preferred vendors in the selection criteria box 78. For example, for a wedding, a link can be provided in the selection criteria area 78 for bridal salons, invitations and photography. The recipient member can click on these links to be connected to preferred vendors who provide these particular services.

As can be seen, multiple revenue streams are available through this invention, thus allowing the operator of the social media network, the preferred vendors, and the Internet financial transaction service providers to take advantage of the inherent characteristics of the social media network to minimize gifting members' transaction costs in giving gifts, and also helping recipient members to receive gifts that they may desire. For example, the operator of the social media network can charge vendors to be included as preferred vendors and therefore eligible to participate in a program according to the present invention. The preferred vendors can also be charged fees for placement, prominence, size and type (words only, or graphics; hyperlink or plain text) of display in the preferred vendors area 72. The preferred vendors can be charged additional amounts for being included in the links in the selection criteria area 78. Also, as with search engines, preferred vendors can be charged for higher placement in search results performed through the selection query area. The Internet financial transactions service providers can also realize a revenue stream by providing financial transactions services to gifting members, such as by charging a percentage of the amount of each gift in order to provide a credit in the amount of that gift.

The present invention gains sufficient efficiencies by operating through the social media network that there need not be any monetary costs to the recipient members or the gifting members in giving or redeeming credits (except for the amount paid by a gifting member to give credits to a recipient member). For example, some of the preferred vendors could be credit card companies that will provide gift cards with the face value of $1.00 for each $1.00 credit, because the preferred vendors that would accept those gift cards would absorb the transaction fees. Similarly, the financial transactions service provider, such as Paypal, may also absorb transaction costs because of the large volume of credits that would be provided using this invention. Thus, the gifting member would be encouraged to use this system because the recipient member would receive $1.00 of value for each $1.00 of credits that the gifting member gives.

Another revenue stream would be click-through advertising revenues paid by preferred vendors to the operator of the social media network each time a recipient member clicks through to that preferred vendor's site through the selection criteria area 78, or through a display in the preferred vendors area 72.

As can be seen, this invention comprises aggregating social media gifts (including micro-gifts) preferably in the form of credits that are redeemable only through preferred vendors. Preferably, the gifts are occasion based. Optionally, revenues would be paid by preferred vendors and financial transactions service providers. Thus, this invention provides for gifting through preferred vendors using a social media network.

Although the invention has been described in connection with the particular preferred embodiment described herein, other features and variations will be apparent to those of ordinary skill in the art. Accordingly, no limitations are to be implied or inferred in this invention except as specifically and explicitly set forth in the attached claims.

### INDUSTRIAL APPLICABILITY

This invention is applicable to any social media network where financial transactions service providers can pay or receive money for credits that can be given to recipient members.

What is claimed is:

1. A process, comprising:
appointing preferred vendors connected to a social media network;
enabling recipient members of said social media network to create their own occasion accounts and to notify other members of said social media network selected by said recipient members about said occasion accounts;
wherein said occasion accounts are designated to receive credits for occasions, whereby gifting members of said social media network can give said credits to said occasion accounts through said social media network; and
allowing only said recipient members to select gifts from said preferred vendors by redeeming said credits through a redemption page containing click through links to said preferred vendors.

2. A process according to claim 1, wherein said occasions are gift-giving occasions.

3. A process according to claim 2, wherein said gift-giving occasions are selected from the group consisting of birthdays, weddings, anniversaries, Christmas, graduations, bridal showers, and baby showers.

4. A process according to claim 1, wherein said allowing step further comprises selecting among said preferred vendors for redeeming said credits using selection criteria.

5. A process according to claim 4, wherein said selection criteria is selected from the group consisting of geographic proximity to said recipient members and personal interest of said recipient members.

6. A process according to claim 1, wherein said enabling step is performed by using occasion accounts linked to registries created by said recipient members.

7. A process according to claim 1, wherein said allowing step further comprising charging said preferred vendors fees for higher placement on said redemption page.

8. A process according to claim 7, further comprising charging said preferred vendors click through advertising charges.

9. A downloadable computer-readable file containing instructions that, when executed, makes a computer into a social media gifting machine, comprising:
software that:
appoints preferred vendors connected to a social media network;
enables recipient members of said social media network to create their own occasion accounts and to notify other members of said social media network selected by said recipient members about said occasion accounts;
wherein said occasion accounts are designated to receive credits for occasions, whereby gifting members of said social media network can give credits to said occasion accounts through said social media network; and
allows only said recipient members to select gifts from said preferred vendors by redeeming said credits through a redemption page containing click through links to said preferred vendors.

10. A computer-readable storage medium containing instructions that, when executed, cause a computer to become a social media gifting machine, comprising:
software that:
appoints preferred vendors connected to a social media network;
enables recipient members of said social media network to create their own occasion accounts and to notify other members of said social media network selected by said recipient members about said occasion accounts;
wherein said occasion accounts are designated to receive credits for occasions, whereby gifting members of said social media network can give credits to said occasion accounts through said social media network; and
allows only said recipient members to select gifts from said preferred vendors by redeeming said credits through a redemption page containing click through links to said preferred vendors.

11. An article of manufacture, comprising:
a computer-readable storage medium;
software stored on said storage medium containing instructions that, when executed, make a computer into a social media gifting machine by:
appointing preferred vendors connected to a social media network;
enabling recipient members of said social media network to create their own occasion accounts and to notify other members of said social media network selected by said recipient members about said occasion accounts;
wherein said occasion accounts are designated to receive credits for occasions, whereby gifting members of said social media network can give credits to said occasion accounts through said social media network; and
allowing only said recipient members to select gifts from said preferred vendors by redeeming said credits through a redemption page containing click through links to said preferred vendors.
